(19) United States
(12) Patent Application Publication
(10) Pub. No.: US 2021/0256477 A1
(43) Pub. Date: Aug. 19, 2021

(54) System and Method for Peer to Peer Sales and Marketing

(71) Applicant: Ferit Erdem Rahvanci, Edgewater, NJ (US)

(72) Inventor: Ferit Erdem Rahvanci, Edgewater, NJ (US)

(21) Appl. No.: 16/793,218

(22) Filed: Feb. 18, 2020

(51) Int. Cl. G06Q 10/10; G06Q 10/06

(52) U.S. Cl. CPC G06Q 10/1053; G06Q 10/063112; G06Q 10/06398

(57) ABSTRACT

The present invention relates to a computer-implemented method and system for those employers that want to outsource freelancer for their sales and marketing or both, for their product”. Specifically, the present invention provides a system and method using review rating system so that the employers can evaluate freelancer before they decide on employing them. The success is determined by the overall average of sales per hour or revenue per hour system on the platform.

### CROSS-REFERENCE TO RELATED APPLICATIONS

No related applications are previously filed.

### FIELD OF THE INVENTION

The present invention relates to a computer-implemented method and system for employers that are interested to outsource freelancers for the purpose of sales and marketing or both. Specifically, the present invention provides a system and method using review rating system so that the employers can evaluate freelancers before they decide on employing them.

### BACKGROUND OF THE INVENTION

In a traditional business, the companies have inhouse team for the sales and marketing for their products. The major drawbacks of employing a full-time employee for the purpose of sales and marketing would be quite expensive for the startups and micro entities.

Another problem is with this traditional business, sometimes full-time employees can be lured away from your company at any time and the cost of replacing the employee as well as delays in project completion can be incredibly costly for the companies.

In view of the foregoing and other relevant problems, there is a need for a method and system for a company which is cost effective, provide a wider range of services and with different options to choose.

Now a days, freelancers constantly evolve to adapt to current marketing trends. Advances in technology continue to facilitate flexible work and there's been a steady increase of platforms that match freelance talent with employers.

Another benefit with this method is freelancers are certainly the most affordable option for an employer or a company. For the reason that no taxes, no benefits, no paid time off, no unemployment taxes, just the services when companies need them.

Therefore, the object of the present invention overcomes the limitations and drawbacks from the prior art. To achieve above and other objects, the present invention anticipates a new and unique business method and system that resolves the limitations and drawbacks.

The present method and system provide “an online platform to the companies who are interested to sell and market their products.

Another object of the present invention is to provide a win-win from both sides of the desk. Employers experience financial savings with independent contractors and lower their risk. Employee use freelancing to tide them over between jobs, to add to income.

The further object of the present invention is that the employer describes the qualifications they want by filling in forms.

The further object of the present invention is that the qualifications forms go to a pool of applications where the people who are looking for a freelance sales and marketing job can register with the platform and search.

The further object of the present invention is that, if the freelancer gets interested in a job, sends an online application to the employer, and then employer accepts the freelancer for their work.

The further object of the present invention is that, the platform charges both the companies and the freelancers, a particular amount of commission for the service it provides.

### SUMMARY OF THE INVENTION

In an embodiment, the present invention provides a computer-implemented method and system for those employers who are interested to outsource freelancers or independent contractors for sales and marketing of their products. Specifically, present invention is based on a review rating system for evaluating freelancer for their work.

In this method firstly, the employer describes the required qualifications by filling in forms. Secondly, the forms go to a pool of applications where the people who are looking for a freelance sales and marketing job can register with the platform and search for the interested work. Thirdly, if the freelancer gets interested in a job, he or she sends an online application to the employer.

Fourthly, the employer selects the efficient freelancer and provides access to the CRM (Customer Relationship Management) data that the previous freelancer has updated the clients that have to be contacted. Fifthly, the freelancer starts contacting the clients and updates the CRM data after every action. Finally, Freelancers get a certain rating so that the employers can evaluate before they decide on employing them for the next project. This platform charges both the companies and the freelancers, a particular amount of commission for the service it provides.

### BRIEF DESCRIPTION OF THE DRAWINGS

The prior and other objects of this invention, the various features thereof, as well as the invention itself, may be more fully understood from the following description, when read together with the accompanying drawings in which:

FIG. 1 schematically visualizes the overall workflow of the system and method of the present invention.

### DETAILED DESCRIPTION OF THE INVENTION

Now referring to the drawings, preferred embodiments of the invention are described below. Reference throughout this specification to “one embodiment”, “this embodiment” and similar phrases, means that a particular feature, structure, or characteristic described in connection with the embodiment is included in at least one embodiment. Thus, the appearances of these phrases in various places throughout this specification are not necessarily all referring to the same embodiment. Furthermore, the particular features, structures, or characteristics may be combined in any suitable manner in one or more embodiments.

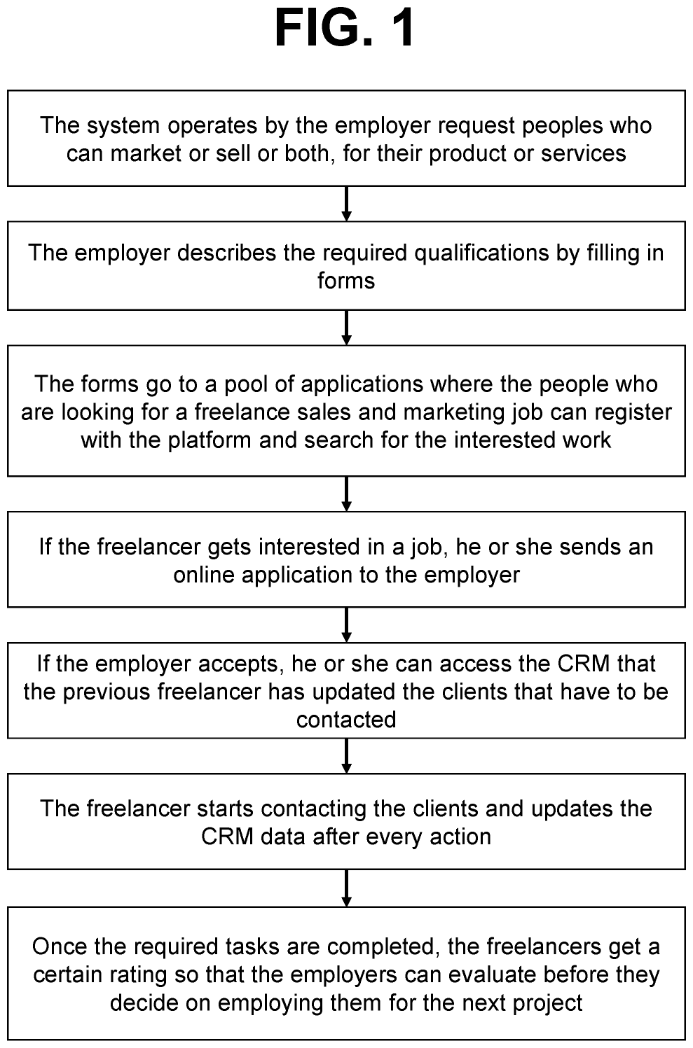

Referring FIG. 1 which describe the overall workflow of the system and method of the present invention. Following are the different steps involved in workflow of the system and method of the present invention.

In one embodiment, present invention described that, this computer-implemented platform serves companies that are interested to outsource the work related to sales and marketing.

The initial step of the system operates by the employer request peoples who can market or sell or both, for their product or services and describes the required qualifications by filling in forms.

In the next step, the forms go to a pool of applications where the people who are looking for a freelance sales and marketing job can register with the platform and search for the interested work.

In the next step, if the freelancer gets interested in a job, he or she sends an online application to the employer, and if the employer accepts, he or she can access the CRM that the previous freelancer has updated the clients that have to be contacted.

In the next step, the freelancer starts contacting the clients and updates the CRM data after every action. Moreover, the freelancers can call or contact the clients in other communication methods and can perform their services in any suitable location they want.

Once the required tasks are completed, the freelancers get a certain rating so that the employers can evaluate before they decide on employing them for the next project.

In one embodiment of the present invention, the rating system works in the following manner:

A new employee comes with no rating until he or she spends a certain amount of time. The success of selection is determined by the overall average of sales per hour or revenue per hour system on the platform. For example, if the average amount of sales made for company A is $300, $0-$100 sales average for a minimum of 4 hours gives 1 star $100-$200 gives two stars, $200-$300 gives three stars, $300-400 gives four star, and any number over $400 gives 5 star. This number can change every day or weekly according to the average sales.

In another embodiment of the present invention, the employers pre-determine the amount of commission they want to pay per revenue to the freelancers. Employers can choose from specific criteria that the platform offers when they determine the commission rates.

In another embodiment of the present invention, the computer-implemented platform charges both the companies and the freelancers, a particular amount of commission for the service it provides.

The present invention is described above with reference to a preferred embodiment. However, those skilled in the art will recognize that changes and modifications may be made in the described embodiment without departing from the nature and scope of the present invention. To the extent that such modifications and variations do not depart from the spirit of the invention, they are intended to be included within the scope thereof.

Having fully and clearly described the invention so as to enable one having skill in the art to understand and practice the same, the invention claimed is:

1. A computer-implemented method and system for the employers that are interested to outsource freelancers for the purpose of sales and marketing of the relevant products or services comprising steps of:
employer describe the qualifications they want by filling in forms;
forms go to a pool of applications where the freelancers are looking for a relevant job;
freelancer can register with the platform and search job details;
interested freelancer, sends an online application to the employer;
employer hires freelancers who met the desired qualifications, and give access the CRM;
freelancer starts working, and updates the CRM data after every action;
freelancer completed the required tasks and submits the completed work to the employer; and
freelancers get a certain rating so that the employers can evaluate before they decide on employing them for the next project.

2. The computer-implemented method and system of claim 1, wherein the success of selection is determined by the overall average of sales per hour or revenue per hour system made by the freelancer on the platform.

3. The computer-implemented method and system of claim 1, wherein the platform charges both the companies and the freelancers, a particular percentage of commission for the service it provides.

4. A review rating system comprising steps of:
a new employee comes with no rating until he or she spends a certain amount of time on the tasks requested by the employer;
specific rating is provided based on the overall average of sales made by the freelancer on hourly basis or the revenue made by the freelancer on the platform per hour;
employer pre-determines the amount of commission they want to pay per revenue to the freelancers based on the rating of freelancer; and
employer chooses from specific criteria that the platform offers when they determine the commission rates.
